(19) United States
(12) Patent Application Publication
(10) Pub. No.: US 2025/0114942 A1
(43) Pub. Date: Apr. 10, 2025

(54) ROBOT SYSTEM AND CALIBRATION METHOD

(71) Applicant: FANUC CORPORATION, Minamitsuru-gun, Yamanashi (JP)

(72) Inventor: Kyouhei KOKUBO, Yamanashi (JP)

(73) Assignee: FANUC CORPORATION, Minamitsuru-gun, Yamanashi (JP)

(21) Appl. No.: 18/836,469

(22) PCT Filed: Feb. 15, 2022
(86) PCT No.: PCT/JP2022/005904

§ 371 Date: Aug. 7, 2024

(51) Int. Cl. B25J 9/16; G06T 7/73

(52) U.S. Cl. CPC B25J 9/1692; G06T 7/73

(57) ABSTRACT

A robot system comprising a robot, a control device configured to control the robot, a positioning target object, and a camera attached to one of the positioning target object and the robot. The control device is configured to cause the camera to capture an image of a display including a first feature from which an origin coordinate of the other one of the positioning target object and the robot can be acquired, and cause the robot to move so that a center of gravity position of the display included in the image acquired by the camera is brought close to a center of the image.

### TECHNICAL FIELD

The present disclosure relates to a robot system and a calibration method.

### BACKGROUND

Conventionally, a technique has been disclosed in which a robot coordinate system and a camera coordinate system are calibrated by capturing an image of a checkerboard attached to a distal end of the wrist of a robot with a camera disposed outside the robot (see, for example, Japanese Unexamined Patent Application, Publication No. 2010-172986).

According to this technique, the robot is moved so that all the intersections are positioned within the image based on the coordinate values of the intersections of the checkerboard that are not positioned in the image captured by the camera.

### SUMMARY

An aspect of the present disclosure is a robot system including a robot; a control device configured to control the robot; a positioning target object; and a camera attached to one of the positioning target object and the robot, wherein the control device is configured to cause the camera to capture an image of a display including a first feature from which an origin coordinate of the other one of the positioning target object and the robot can be acquired, and cause the robot to move so that a center of gravity position of the display included in the image acquired by the camera is brought close to a center of the image.

### BRIEF DESCRIPTION OF DRAWINGS

FIG. 1 is a perspective view showing an overall configuration of a robot system according to an embodiment of the present disclosure.

FIG. 2 is a diagram showing an example of a calibration pattern used in the robot system of FIG. 1.

FIG. 3 is a view showing an example of an origin of carriage coordinate system and directions of X and Y coordinates indicated by dots having a large diameter in the calibration pattern of FIG. 2.

FIG. 4 is a diagram showing an example of an image in the case where the entire calibration pattern of FIG. 2 is arranged within a field of view of a camera.

FIG. 5 is a flowchart for explaining a calibration method using the robot system of FIG. 1.

FIG. 6 is a view showing an example of an image when a part of the calibration pattern of FIG. 2 is arranged in the field of view of the camera.

FIG. 7 is a view showing another example of an image in the case where a part of the calibration pattern of FIG. 2 is arranged in the field of view of the camera.

FIG. 8 is a view showing another example of the calibration pattern of FIG. 2.

FIG. 9 is a diagram showing an example of a center of gravity position when the weight of the dots having large diameter are increased in the calculation of the center of gravity position in the image of FIG. 7.

FIG. 10 is a view showing another example of the calibration pattern of FIG. 2.

FIG. 11 is a flowchart showing a modification of the calibration method of FIG. 5.

FIG. 12 is a perspective view showing the entire configuration of a modification of the robot system shown in FIG. 1.

FIG. 13 is a perspective view showing the entire configuration of another modification of the robot system of FIG. 1.

FIG. 14 is a perspective view showing the entire configuration of another modification of the robot system of FIG. 1.

### DETAILED DESCRIPTION OF EMBODIMENTS

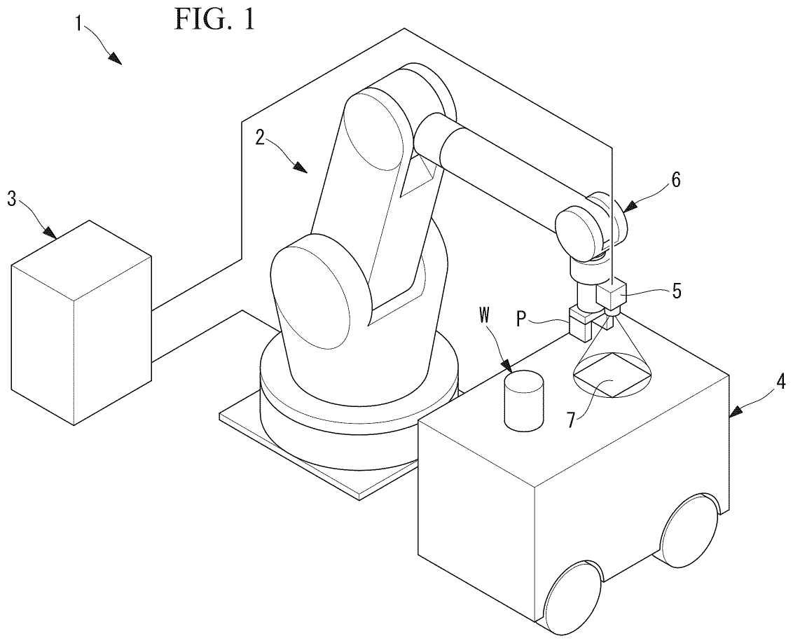

As shown in FIG. 1, the robot system 1 according to the present embodiment includes a robot 2, a control device 3, a positioning target object, and a camera 5.

The robot 2 is, for example, a vertical six axis articulated robot fixed to a horizontal installation surface such as a floor surface and the like. For example, a tool P such as a hand and the like that performs work on a workpiece W is mounted on a distal end of a wrist 6 of the robot 2. Any form or structure of the robot 2 may be adopted. Further, any type of tool P may be attached to the distal end of the wrist 6 of the robot 2.

The positioning target object is, for example, a carriage 4 that carries the workpiece W and moves on a floor surface to supply the workpiece W to the robot 2. The carriage 4 may be an unmanned vehicle or a carriage manually moved by an operator.

A calibration pattern (a display) 7, which is described later, is fixed to a surface of the carriage 4, for example a top surface. The fixed position of the calibration pattern 7 may be any position on the carriage 4 as long as the robot 2 can face the camera 5.

The camera 5 is a two dimensional camera, and is fixed to the tool P mounted on the robot 2. The camera 5 may be directly fixed to the distal end of the wrist 6 of the robot 2. A camera coordinate system is precisely associated with a robot coordinate system by performing calibration in advance.

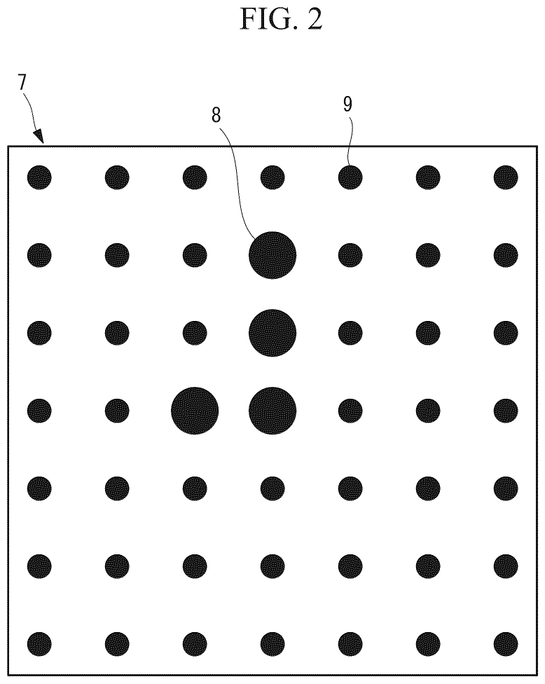

The calibration pattern 7 is a display including a feature (a first feature) indicating an origin and a direction of a coordinate axis of the carriage coordinate system fixed to the carriage 4, and is, for example, a dot pattern including a plurality of circular dots 8 and 9 arranged in a square array pattern at predetermined intervals as shown in FIG. 2.

The dot pattern of FIG. 2 includes two types of dots 8 and 9 having different outer diameter dimensions, and includes four dots (first feature) 8 having large outer diameter dimensions (large diameter ones) arranged in an L shape, and a plurality of dots (second feature) 9 having small outer diameter dimensions (small diameter ones) arranged around the four dots. That is, the four dots 8 having the large diameter are arranged in an L shape by three dots 8 arranged in the first direction, and the other dot 8 arranged in the second direction orthogonal to the first direction with respect to the dot 8 at the end of the three dots 8.

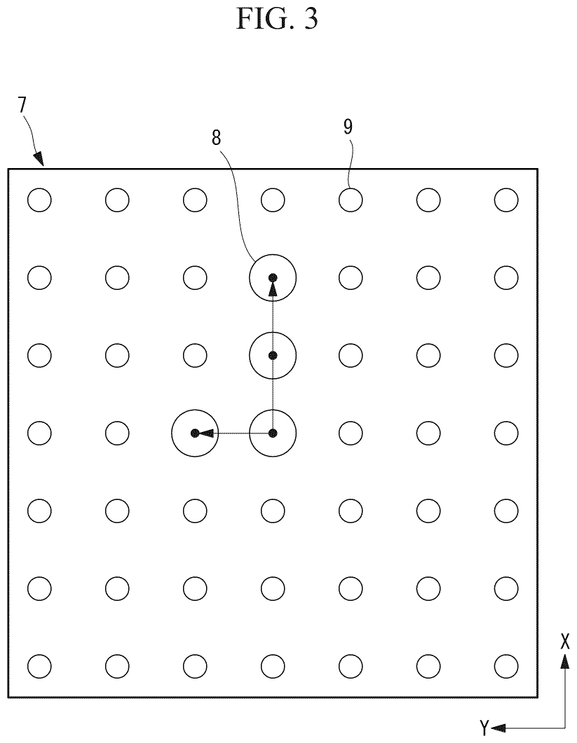

As shown in FIG. 3, the center of the dot 8 having the large diameter located at the corner of the L shape is associated with the origin position of the carriage coordinate system. And, a straight line which connects the centers of the three dots 8 having the large diameter, and which extends in the first direction is associated with a X axis direction of the carriage coordinate system, and a straight line which connects the centers of two dots 8 having the large diameter and which extends in the second direction is associated with a Y axis direction of the carriage coordinate system.

Here, the fact that the center of the dot 8 having the large diameter positioned at the corner of the L shape is associated with the origin position of the carriage coordinate system means both cases in which the center of the dot 8 having the large diameter positioned at the corner of the L shape is the origin position of the carriage coordinate system and in which the center of the dot 8 having the large diameter positioned at the corner of the L shape is not the origin position of the carriage coordinate system. That is, the origin position of the carriage coordinate system may be acquired by acquiring the center position of the dot 8 having the large diameter at the corner of the L shape, or the origin position of the carriage coordinate system set at a different position may be acquired.

Similarly, the fact that the straight line connecting the centers of the dots 8 having the large diameter is associated with the axial direction of the carriage coordinate system means both cases in which the directions of the straight lines correspond with the axial directions, and in which the directions of the straight lines are different from the axial directions. That is, by acquiring two straight lines connecting the centers of the dots 8 having the large diameter, the X coordinate and the Y coordinate of the carriage coordinate system may be acquired, or the X coordinate and the Y coordinate of the carriage coordinate system extending in a direction different from the acquired straight lines may be acquired.

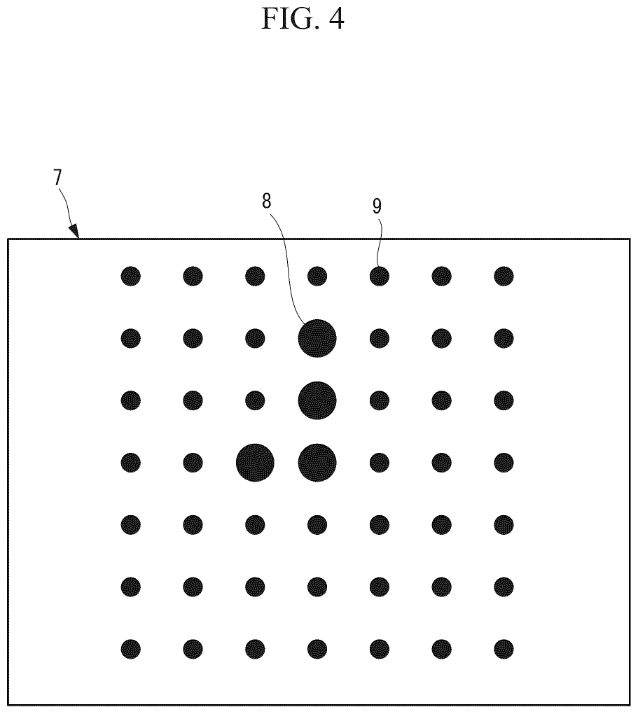

The plurality of dots 9 having the small diameter are arranged so as to be distributed over a predetermined range around the dots 8 having the large diameter. The predetermined range is, for example, a range in which the entire calibration pattern 7 can be arranged within the field of view of the camera 5 when the camera 5 is arranged at a position distant by a predetermined distance from the calibration pattern 7 as shown in FIG. 4.

When the carriage 4 is positioned in a state where the carriage 4 is roughly positioned with respect to the robot 2, the control device 3 executes calibration for associating the robot coordinate system with the carriage coordinate system.

Hereinafter, a calibration method according to an embodiment of the present disclosure will be described.

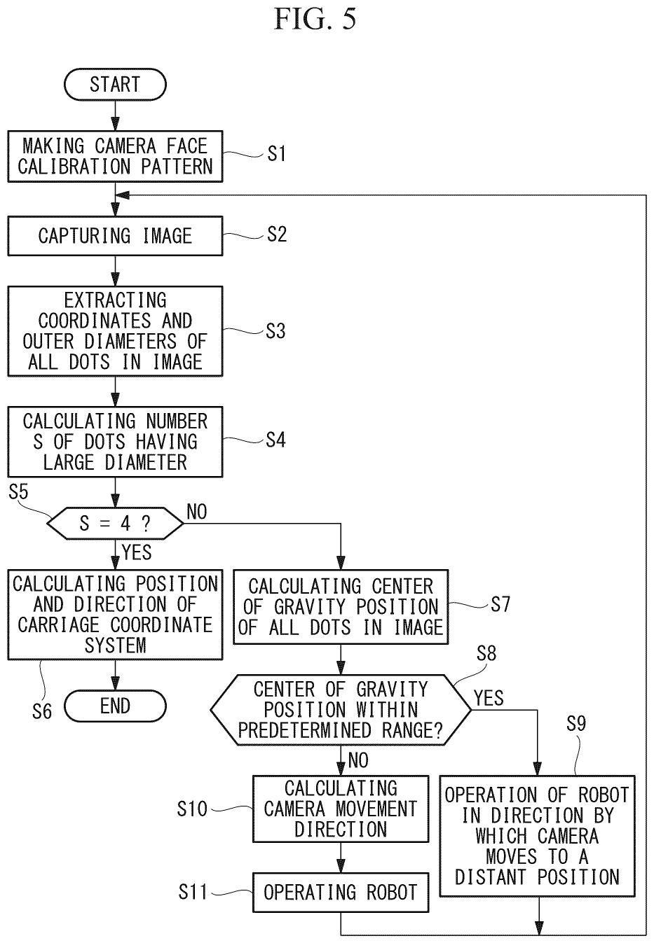

In the calibration method according to the present embodiment, as shown in FIG. 5, first, the control device 3 controls the robot 2 to cause the camera 5 to face the calibration pattern 7 provided on the top surface of the carriage 4 (Step S1). Then, the control device 3 operates the camera 5 to cause the camera 5 to capture the calibration pattern 7 (Step S2).

The control device 3 processes the image captured by the camera 5, extracts the four dots 8 having the large diameter in the image, and determines whether or not all of the four dots 8 having the large diameter are included. To be more specific, the coordinate positions and the outer diameter dimensions of all the dots 8 and 9 included in the image are extracted (Step S3), and the number S of dots 8 having the larger outer diameter dimensions than the other dots 9 is counted (Step S4).

It is determined whether or not the number S of the dot 8 having the large diameter is four (Step S5). As shown in FIG. 4, when the number S of the dots 8 having the large diameter in the image is four, the position and direction of the carriage coordinate system are calculated from the coordinates of the center positions of the dots 8 having the large diameter in the image (Step S6). By the process, the calibration for precisely associating the robot coordinate system with the carriage coordinate system is completed.

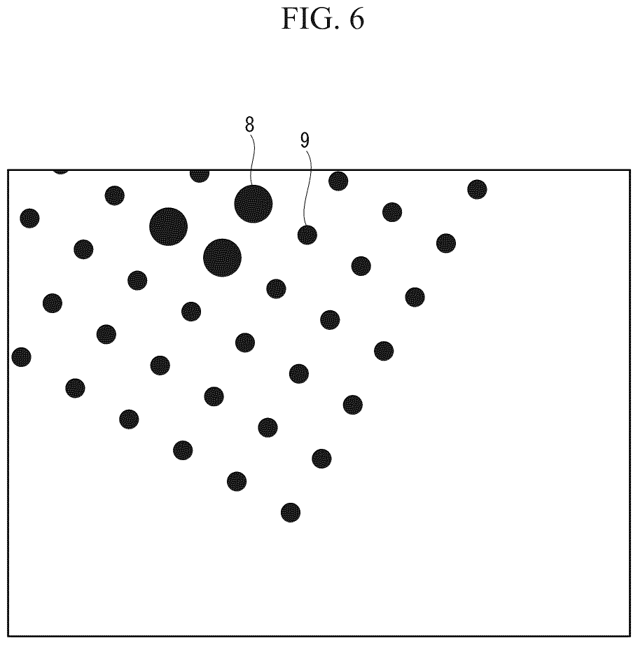

On the other hand, as shown in FIG. 6, when the image includes three or less dots 8 having the large diameter, control device 3 calculates a center of gravity position G of all dots 8 and 9 included in the captured image (Step S7). Here, the center of gravity position G of the dots 8 and 9 can be calculated by averaging the coordinates of the center positions of the respective dots 8 and 9. That is, the coordinates of the center positions of the dots 8 and 9 on the image are added for each component, and the result is divided by the number of additions, whereby the average value can be obtained.

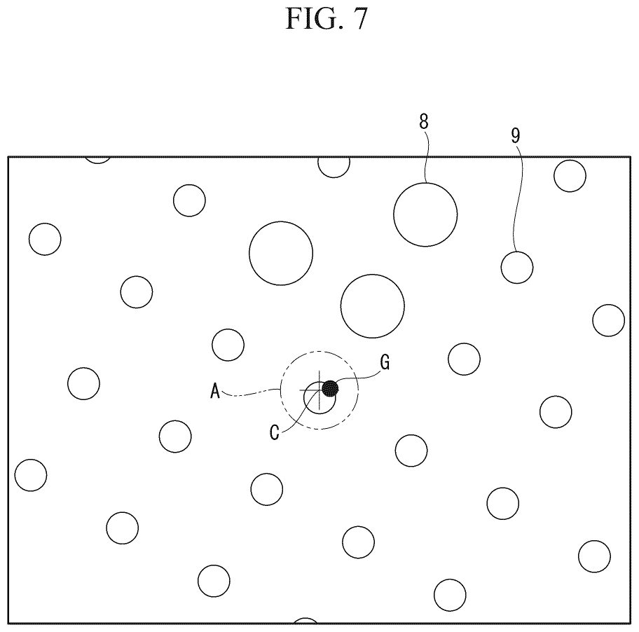

Then, as shown in FIG. 7, the control device 3 determines whether or not the coordinate of the calculated center of gravity position G is within a circle of a predetermined radius (a predetermined range) A, which is shown by a chain line, with respect to a center position (a center) C of the image (Step S8). Here, the predetermined radius is, for example, the maximum amount by which the center of the calibration pattern 7 can be deviated with respect to an optical axis of the camera 5 while allowing all of the four dots 8 with the large diameter to be within the field of view in a state in which the camera 5 is disposed at a distance position so that the entire calibration pattern 7 can be placed in the field of view of the camera 5.

When the calculated center of gravity position G is within the circle of the predetermined radius A with respect to the center position C of the image, the dots 8 and 9 are uniformly distributed in the image as shown in FIG. 7. Therefore, after the control device 3 operates the robot 2 in a direction to move the camera 5 away from the calibration pattern 7 (Step S9), and the processes are repeated from Step S2. The amount of movement of the robot 2 in this case may be determined in advance.

That is, when the four dots 8 having the large diameter are not included in the image and the dots 8 and 9 are uniformly distributed in the image, it can be determined that the camera 5 is too close to the calibration pattern 7. Therefore, by moving the robot 2 in a direction in which the camera 5 moves away from the calibration pattern 7, it becomes possible to appropriately capture the calibration pattern 7.

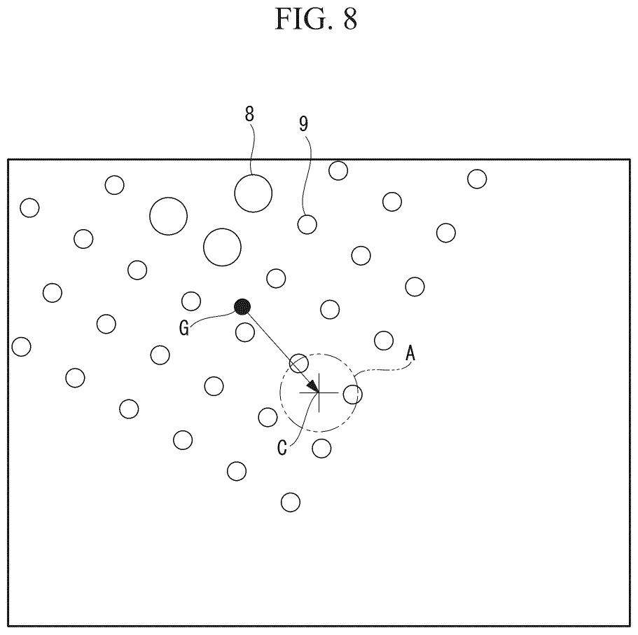

As shown in FIG. 8, when it is determined that the calculated coordinate of the center of gravity position G is located outside the predetermined range A with respect to the center position C of the image, the control device 3 calculates a movement direction having the center of gravity position G as a origin point and the center position C of the image as an end point (Step S10). Then, the control device 3 operates the robot 2 so that the calibration pattern 7 is moved by a predetermined distance in the image along the calculated movement direction (Step S11). Thereafter, the processes from Step S2 are repeated.

That is, when the center of gravity position G is located outside the predetermined range A with respect to the center position C of the image, the calibration pattern 7 is disproportionately distributed in one direction in the image, and thus the center of gravity position G is moved in a direction approaching the center position C. Thus, the camera 5 and the calibration pattern 7 can be brought close to a positional relationship in which all the dots 8 having the large diameter included in the calibration pattern 7 are positioned in the visual field of the camera 5.

As described above, according to the robot system 1 and the calibration method of the present embodiment, the position and the direction in the carriage coordinate system are calculated based on the four dots 8 having the large diameter in the captured image, and thus it is not necessary to store the number of the dots 8 and 9. Further, unlike the related art, since it is not necessary to perform a complicated process of estimating the center positions of the dots 8 and 9 located outside the image, there is an advantage that it is possible to accurately acquire the carriage coordinate system by a simpler process.

Further, when the number of the dots 8 having the large diameter in the image is three or less, the center of gravity G is moved by a predetermined distance in a direction of approaching the center position C of the image, and therefore, there is an advantage that the robot 2 does not have to be moved largely. That is, since all of the four dots 8 having the large diameter need only be arranged within the image, it is not necessary to move the robot so that the four dots 8 having the large diameter are arranged in the vicinity of the center of the image, and it is possible to avoid interference between a peripheral device and the robot 2 by limiting movement of the robot 2.

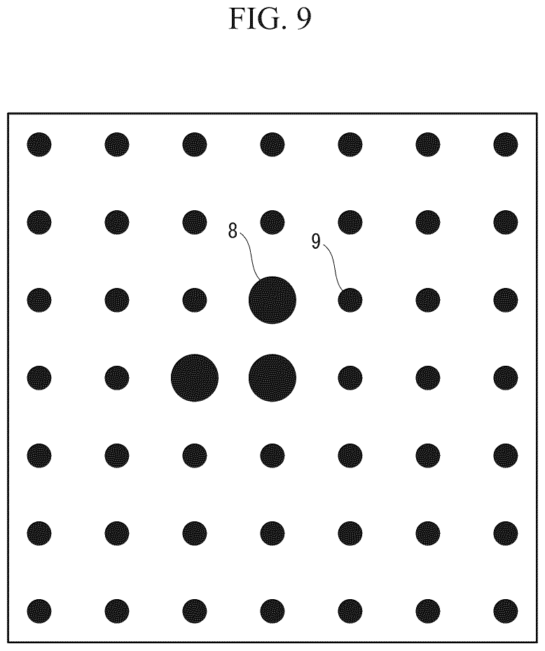

In the present embodiment, the first feature indicating the origin point and the direction of the coordinate axis of the carriage coordinate system is configured by the four dots 8 having the large diameter in the calibration pattern 7, but may be configured by three as illustrated in FIG. 9. In this case, the center position of the dot 8 located at the corner is associated with the origin point of the carriage coordinate system, the straight line connecting the center positions of one of the two dots 8 is associated with the X-axis direction of the carriage coordinate system, and a straight line connecting the center positions of the other of one of the two dots 8 is associated with the Y-axis direction of the carriage coordinate system. The dots 9 having the small diameter and the dots 8 having the large diameter may be replaced with each other.

Further, when the number of the dots 8 having the large diameter in the image is three or less, the center of gravity G is moved by a predetermined distance in a direction of approaching to the center position C of the image, however, instead of this, the center of gravity G may be moved by a distance that connects the center of gravity G and the center position C of the image. This makes it possible to reduce the number of repetitions of the processes and to arrange all of the four dots 8 having the large diameter in the image at an early stage.

Further, when calculating the center of gravity position G of the dots 8 and 9 in the image, the calculation is performed with an assumption that all of the dots 8 and 9 have the same weight, but instead of this, the center of gravity position G may be calculated by giving a larger weight to the dot 8 having the large diameter than to the dot 9 having the small diameter. by the process, the center of gravity position G can be brought closer to the dot 8 having the large diameter, and particularly, when the movement is performed by the distance that connects the center of gravity position G and the center position C of the image, all of the four dots 8 having the large diameter can be arranged in the image at an earlier stage.

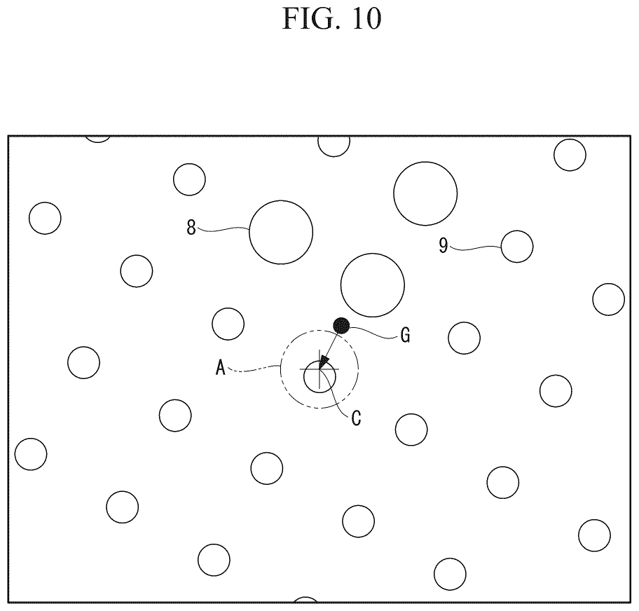

Further, by giving a weight larger than that of the dot 9 having the small diameter to the dots 8 having the large diameter, as shown in FIG. 10, even when the dot 8 having the large diameter is included in a part of the dots 8 and 9 evenly distributed in the image as in FIG. 7, it is possible to arrange the center of gravity position G at a position apart from the center position C of the image.

Further, the dot 8 having the large diameter is arranged in the vicinity of the center of the dots 9 having the small diameter, however, the present disclosure is not limited to this, and the large diameter dots 8 may be arranged at the corner of the dot pattern composed of the dots 9 having the small diameter. Alternatively, a dot pattern including only four dots 8 having the large diameter may be employed.

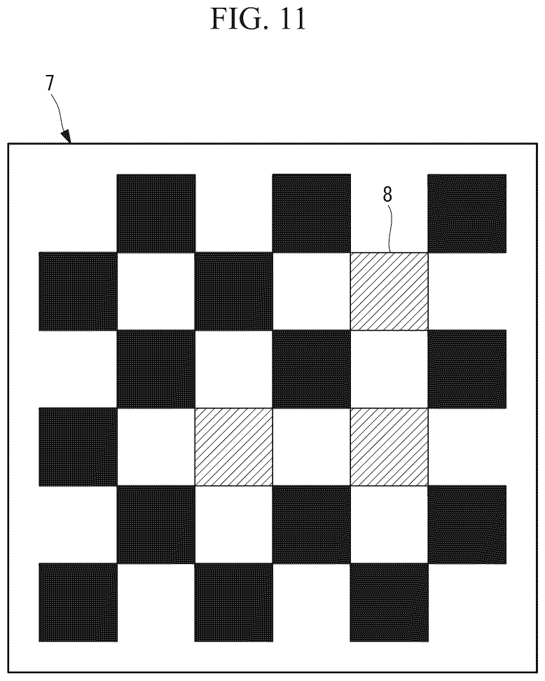

Further, as the display for calibrating the carriage coordinate system with respect to the robot coordinate system, the calibration pattern consisting of the dot pattern is adopted, but the present disclosure is not limited to this. For example, a chess pattern shown in FIG. 11 may be adopted. In this chess pattern, instead of the dots 8 having the large diameter, three squares of different colors may be arranged in an L shape.

Further, the display for calibration is not limited to the pattern, and a characteristic shape on the surface of the carriage, for example, a characteristic contour shape of the housing of the carriage 4, the position of a bolt, or the like may be used as the display for calibration.

Also, in the flowchart of FIG. 5, when three or less dots 8 having the large diameter are detected and the center of gravity positions G of all dots 8 and 9 in the image exist within a predetermined range with respect to the center position C of the image, the camera 5 is moved in a direction away from the calibration pattern 7. Instead, an actual center-to-center distance T0 of the adjacent dots 8 and 9 may be stored.

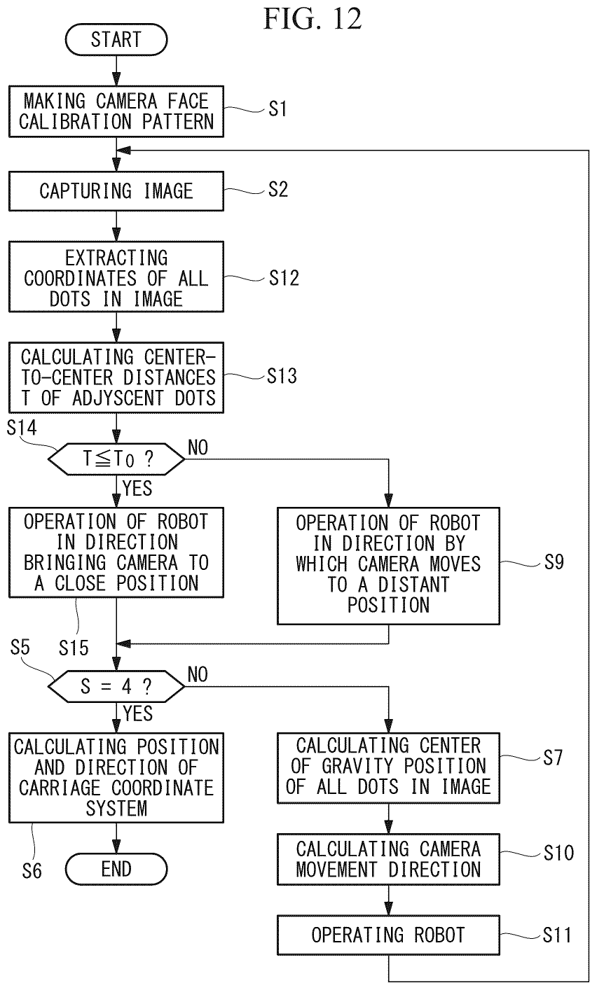

In this case, as shown in FIG. 12, at the stage where the coordinates of the center positions of all the dots 8 and 9 are calculated (Step S12), center-to-center distances T between the centers of the adjacent dots 8 and 9 in the image are calculated (Step S13). Then, the stored center-to-center distance T0 is compared with the calculated center-to-center distance T (Step S14).

The camera 5 may be moved in a direction in which the center-to-center distance T between the adjacent dots 8 and 9 in the image is equal to the actual center-to-center distance between the adjacent dots 8 and 9 (Steps S9 and S15). In this case, the calculation accuracy can be improved by detecting the center-to-center distance T between the dots 8 and 9 that are most distant from each other in the image and calculating the center-to-center distance T between the adjacent dots 8 and 9 based on the detected center-to-center distance T.

That is, even when the camera 5 and the calibration pattern 7 are shifted from each other to such an extent that the dots 8 having the large diameter cannot be positioned in the image due to the dots 9 having the small diameter around the dot 8 having the large diameter, the dot 8 having the large diameter can be moved into the image by using the dots 9 having the small diameter. Further, the dots 9 having the small diameter can be used to accurately calculate the distance between the camera 5 and the calibration pattern 7.

In the flowchart of FIG. 5, the dots 8 having the large diameter are detected separately from the dots 9 having the small diameter, and when the number of the detected dots 8 having the large diameter is three or less, the center of gravity position G of all the dots 8 and 9 in the image is calculated. Instead of this, the center of gravity position G of all the dots 8 and 9 in the image may be calculated without distinguishing the dots 9 having the small diameter and the dots 8 having the large diameter, and the dots 8 having the large diameter may be identified after bringing the center of gravity position G close to the center position of the image.

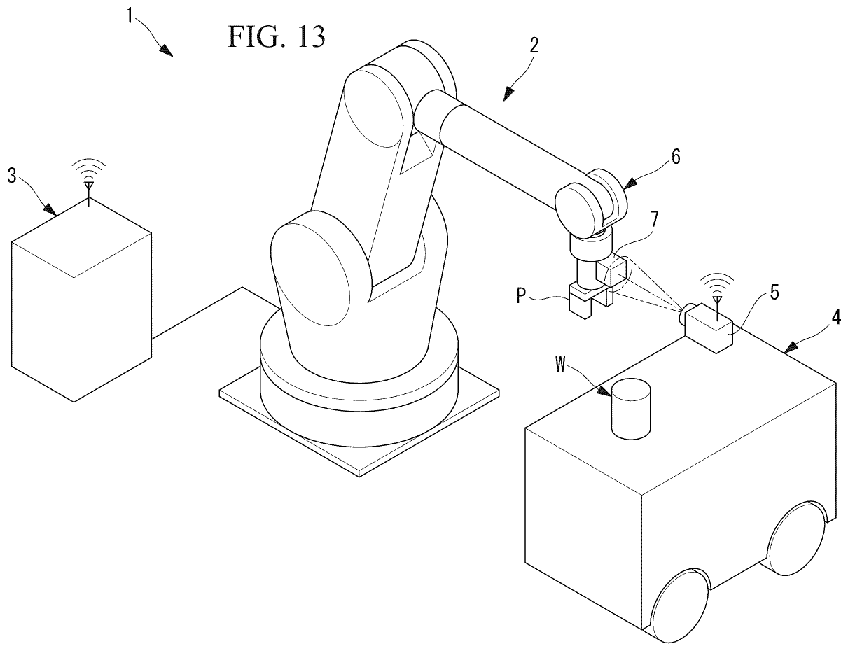

Also, in the robot system 1 according to the present embodiment, the case where the images of the calibration pattern 7 fixed to the carriage 4 are captured by the camera 5 mounted on the robot 2 has been described. Alternatively, as shown in FIG. 13, the camera 5 may be mounted on the carriage 4, and the calibration pattern 7 may be fixed to the tool P of the robot 2.

In this case, the camera coordinate system is precisely associated with the carriage coordinate system by the calibration carried out in advance. Further, the control device 3, for example, wirelessly operates the camera 5 and receives the image acquired by the camera 5.

When the carriage 4 is roughly positioned with respect to the robot 2, the control device 3 executes the calibration for associating the robot coordinate system with the carriage coordinate system. That is, the control device 3 controls the robot 2 so as to hold the calibration pattern 7 to face the camera 5 at first. Then, the control device 3 operates the camera 5 to capture an image of the calibration pattern 7 and receives the acquired image. The processes from Step S3 of FIG. 5 may be performed thereafter.

In this case, as in the above-described embodiment, the robot 2 is moved based on the dots 8 and 9 in the acquired image so that all of the four dots 8 having the large diameter are positioned in the image, and the robot coordinate system and the carriage coordinate system can be easily calibrated.

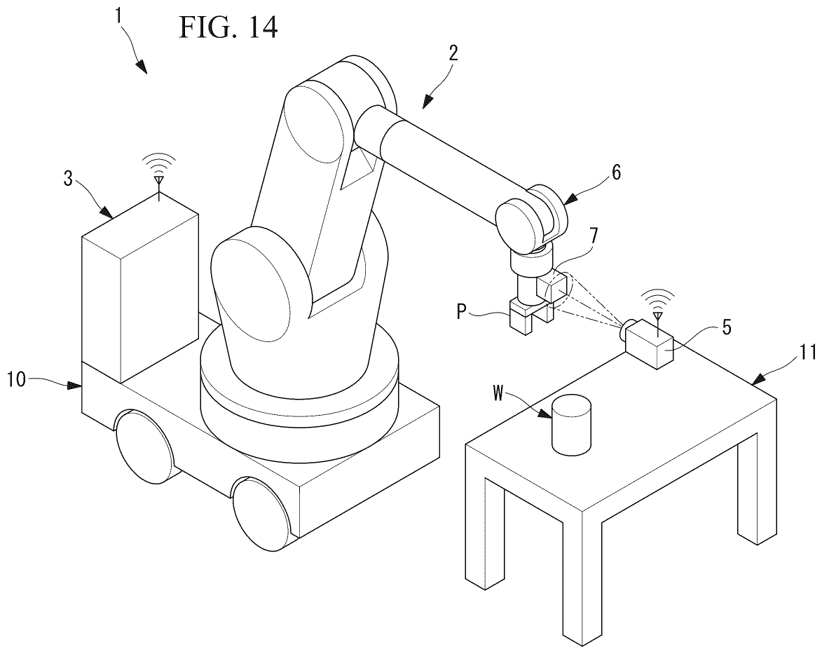

Further, as shown in FIG. 14, the present disclosure may be applied to a case where the robot 2 and the control device 3 are mounted on a carriage 10, and work is performed on a workpiece W on a table (positioning target object) 11 in a state where the robot 2 and the control device 3 are roughly positioned with respect to the table 11 on which the workpiece W is mounted. In this case, the carriage 10 may be an unmanned carrier or a manual carriage.

That is, the present disclosure can be applied to a case where the calibration pattern 7 mounted on the robot 2 is opposed to the camera 5 which is fixed to the table 11, and the coordinate system fixed to the table 11 and the robot coordinate system are calibrated. In this case, the camera 5 may be mounted on the robot 2, and the calibration pattern 7 may be fixed to the table 11. Alternatively, the camera 5 or the calibration pattern 7 may be fixed at a position separated from the table 11.

1. A robot system comprising;
a robot;
a control device configured to control the robot;
a positioning target object; and
a camera attached to one of the positioning target object and the robot, wherein the control device is configured to cause the camera to capture an image of a display including a first feature from which an origin coordinate of the other one of the positioning target object and the robot can be acquired, and cause the robot to move so that a center of gravity position of the display included in the image acquired by the camera is brought close to a center of the image.

2. The robot system according to claim 1, wherein the control device is further configured to determine whether or not a whole of the first feature is included in the image acquired by the camera, and acquire the origin coordinate of the other one of the positioning target object and the robot based on the first feature in the image when it is determined that the whole of the first feature is included in the image.

3. The robot system according to claim 2, wherein the control device is further configured to operate the robot so that the center of gravity position of the display included in the image is brought close to the center of the image when it is determined that the whole of the first feature is not included in the image acquired by the camera.

4. The robot system according to claim 1,
wherein the display includes a second feature that is distributed in a predetermined range around the first feature.

5. The robot system according to claim 4, wherein the control device is further configured to cause the camera to capture an image of the display again after moving the robot in a direction away from the display when it is determined that the whole of the first feature is not included in the image acquired by the camera and the calculated center of gravity position is located at a position within a predetermined range of the center of the image.

6. The robot system according to claim 4, wherein the control device is further configured to calculate the center of gravity position using the whole of the display included in the image.

7. The robot system according to claim 4, wherein the control device is further configured to calculate the center of gravity position by giving a larger weight to the first feature than to the second feature included in the image.

8. The robot system according to claim 3, wherein the control device is further configured to calculate the center of gravity position using only the first feature included in the image.

9. A calibration method comprising:
capturing an image, with a camera attached to one of a robot and a positioning target object, of a display including a first feature from which an origin coordinate of the other one of the robot and the positioning target object can be acquired;
determining whether or not a whole of the first feature is included in the image captured by the camera,
acquiring the origin coordinate based on the first feature in the image when it is determined that the first feature is included in the image;
controlling the robot to make a center of gravity of the display included in the image close to a center of the image when it is determined that the display is not included in the image; and
repeating the processes from capturing the image of the display.
